(19) United States
(12) Patent Application Publication
(10) Pub. No.: US 2024/0386175 A1
(43) Pub. Date: Nov. 21, 2024

(54) TIMING ANALYSIS FOR NON-SCAN LATCHES

(71) Applicant: International Business Machines Corporation, Armonk, NY (US)

(72) Inventors: Kerim KALAFALA, Rhinebeck, NY (US); Michael Hemsley WOOD, Wilmington, DE (US); Rahul M. RAO, Bangalore (IN); Tsz-Mei KO, Poughkeepsie, NY (US); Daniel DEDRICK, Stanford, NY (US); Eric FOREMAN, Fairfax, VT (US); Robert John ALLEN, Jericho, VT (US); Nathan BUCK, Underhill, VT (US); Hemlata GUPTA, Hopewell Junction, NY (US); Karthik RAJASHEKARA, Bengaluru (IN)

(21) Appl. No.: 18/319,934

(22) Filed: May 18, 2023

(51) Int. Cl. G06F 30/3312

(52) U.S. Cl. CPC G06F 30/3312; G06F 2119/12

(57) ABSTRACT

The present disclosure describes systems and methods for performing timing analysis of circuit designs. According to an embodiment, a method includes assigning a timing margin to a non-scan latch of a circuit design and performing a timing analysis on the circuit design using the timing margin for the non-scan latch to produce timing results for the circuit design. The timing results include a slack value. The method also includes calculating a credit based on the slack value and updating the slack value based on the credit.

### BACKGROUND

The present disclosure relates to electronic circuit design, and more specifically, to timing analysis of circuit designs.

### SUMMARY

The present disclosure describes systems and methods for performing timing analysis of circuit designs. According to an embodiment, a method includes assigning a timing margin to a non-scan latch of a circuit design and performing a timing analysis on the circuit design using the timing margin for the non-scan latch to produce timing results for the circuit design. The timing results include a slack value. The method also includes calculating a credit based on the slack value and updating the slack value based on the credit. Other embodiments include a system that performs the method and a computer readable medium storing instructions that, when executed by a processor, cause the processor to perform the method.

### BRIEF DESCRIPTION OF THE DRAWINGS

FIG. 1 illustrates an example system performing timing analysis.

FIG. 2 illustrates the example system of FIG. 1 determining a credit.

FIG. 3 illustrates the example system of FIG. 1 adjusting an electronic circuit design.

FIG. 4 is a flowchart of an example method performed in the system of FIG. 1.

FIG. 5 illustrates an example computing environment.

### DETAILED DESCRIPTION

During electronic circuit design, a designer may select circuit components and connect the circuit components together to form a circuit design. Each circuit component may introduce delays into the circuit design. These delays may impact the performance of the circuit design, and in some instances, may prevent the circuit design from operating correctly. For example, the delays may cause timing issues that prevent electronic signals from reaching certain portions of the circuit design when those portions of the circuit design are set to process or handle those electronic signals. To help prevent timing issues from negatively impacting operation, the designer may perform timing analysis (e.g., static timing analysis) during the circuit design process to determine delays and to identify potential timing issues. The designer may then adjust the circuit design to reduce delays or to resolve timing issues.

Some circuit designs include latches that store received values during operation. To make it easier to test these latches, the designer may use scan latches (which may also be referred to as scanable latches) rather than non-scan latches (which may also be referred to as non-scanable latches). A scan latch may include an additional input that allows values to be sent directly into the latch during testing (e.g., as opposed to propagating the value through the circuit design to the latch). A non-scan latch may not include this additional input, and so, the non-scan latch may be tested by propagating values through the circuit design to the non-scan latch. Thus, it may be more difficult to test a non-scan latch relative to a scan latch. The non-scan latch, however, may consume less power than the scan latch.

During timing analysis, to ensure that non-scan latches are not on a limiting path in the circuit design (e.g., the non-scan latches do not limit the frequency of the clock signal used to drive the circuit design), timing margins may be introduced for the non-scan latches. These timing margins may relax some of the timing constraints on the non-scan latches, but the timing margins may also introduce excess pessimism into the timing analysis. As a result, it may be difficult to determine how to adjust the non-scan latches or other portions of the circuit design. For example, the pessimism may reduce opportunities for power recovery adjustments.

The present disclosure describes a system and method for improving timing analysis for non-scan latches, in certain embodiments. Generally, the system may analyze the slack values (e.g., a measure of whether a signal reaches a destination within a required amount of time) produced during timing analysis to determine whether a credit should be applied to reduce the impact of timing margins introduced for non-scan latches. The credit may be determined as a function of the slack values up to a certain cutoff for the slack values. By adjusting the slack values using the credit, the system may reduce or offset some of the pessimism introduced by unnecessary or overly large timing margins for the non-scan latches. In this manner, the system may provide or reveal additional adjustments that may be made to the circuit design, including providing opportunities for power recovery.

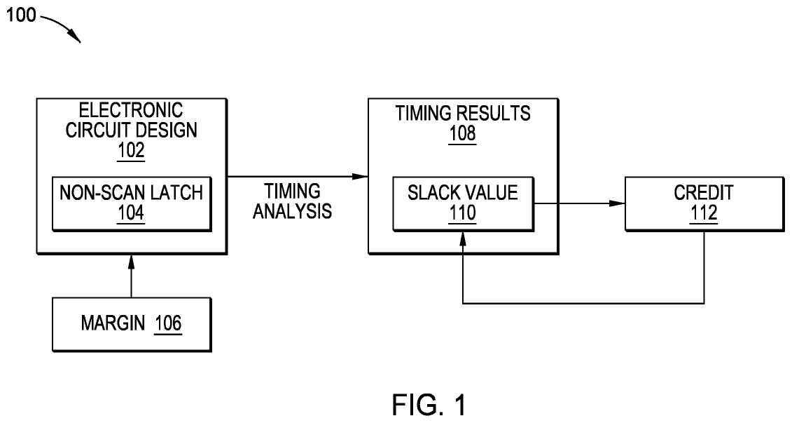

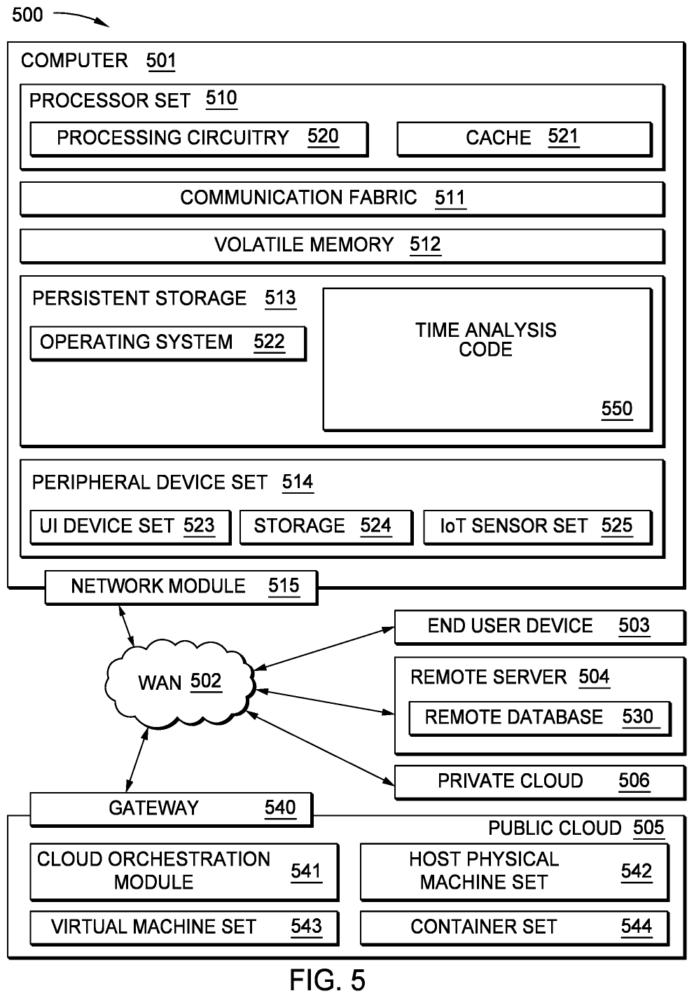

FIG. 1 illustrates an example system 100. Generally, the system 100 may be a computer system (e.g., the computer 501 shown in FIG. 5). Generally, the system 100 performs timing analysis for an electronic circuit design to determine timing results for the electronic circuit design. The system 100 may then determine credits based on slack values in the timing results. The system 100 may update the slack values in the timing results using the credits to produce more accurate timing results for the electronic circuit design, in particular embodiments.

The system 100 may receive an electronic circuit design 102 from a designer. The electronic circuit design 102 may include one or more electronic circuit components that are connected to each other to form the electronic circuit design 102. The electronic circuit design 102 may include any suitable types of electronic circuit components (e.g., gates, latches, resistors, capacitors, inductors, etc.). In the example of FIG. 1, the electronic circuit design 102 includes one or more non-scan latches 104.

The non-scan latch 104 may be a circuit component that stores values propagated to the non-scan latch 104 from other portions of the electronic circuit design 102. Unlike a scan latch (which includes an input through which values may be stored directly into the scan latch), the non-scan latch 104 may not include an additional input through which values may be stored directly into the non-scan latch 104 (e.g., as opposed to propagating the value to the non-scan latch 104 from other portions of the electronic circuit design 102). As a result, the non-scan latch 104 may generally consume less power than a scan latch, but the non-scan latch 104 may be more difficult to test.

Because the non-scan latch 104 may be difficult to test, a margin 106 is typically applied to the non-scan latch 104 for purposes of timing analysis. The margin 106 may relax timing constraints for the non-scan latch 104 so that the non-scan latch 104 does not limit the frequency of a clock signal driving the electronic circuit design 102 (e.g., help ensure that the non-scan latch 104 is not on the frequency limiting path). The margin 106, however, may introduce excess pessimism for the non-scan latch 104 during the timing analysis. This excess pessimism may make it more difficult to detect or determine certain adjustments to the electronic circuit design 102 that would improve the electronic circuit design 102. For example, certain adjustments or opportunities for power recovery may be missed.

The system 100 may perform timing analysis on the electronic circuit design 102 to produce timing results 108. The timing results 108 may include values that indicate characteristics of the electronic circuit components of the electronic circuit design 102 that impact timing. For example, the timing results 108 may include one or more slack values 110 for the non-scan latch 104. The slack values 110 may indicate a difference between when a signal arrives or leaves the non-scan latch 104, and when the signal is scheduled or supposed to arrive or leave the non-scan latch 104. A negative slack value 110 may indicate that the signal is arriving or leaving the non-scan latch 104 too late. A positive slack value 110 may indicate that the signal is arriving or leaving the non-scan latch 104 early. Generally, if a signal arrives too late, the electronic circuit design 102 may not operate correctly.

The slack values 110 for the non-scan latch 104 may take into account the margin 106 applied to the non-scan latch 104. As a result, the slack values 110 may include excess pessimism introduced by the margin 106. Thus, the slack values 110 may make it more difficult to determine adjustments to be made to the electronic circuit design 102 (e.g., to recover power or improve timing).

The system 100 may update the timing results 108 by calculating a credit 112 using the slack values 110. Generally, the credit 112 may be larger for positive slack values 110 than for negative slack values 110. The system 100 may adjust the slack values 110 by adding the credit 112 to the slack values 110. By adjusting the slack values 110, the system 100 may remove some of the pessimism introduced by the margin 106, which may provide opportunities to detect or determine adjustments to the electronic circuit design 102, in particular embodiments.

The credit 112 may be determined subject to certain constraints. For example, the credit 112 may be subject to a minimum, a maximum, or a cutoff. The minimum credit may be added to the slack value 110 regardless of the value of the slack value 110. The credit 112 may be limited to the maximum credit regardless of how large the slack value 110 is. In some embodiments, the system 100 limits the credit 112 to the maximum credit when the slack value 110 exceeds a cutoff. For slack values 110 less than the cutoff, the system 100 may calculate the credit 112 as a function of the slack values 110. In this manner, the system 100 may constrain the credit 112 that is used to update the timing results 108.

In some embodiments, the system 100 limits the determination of the credit 112 to non-scan latches 104 in the electronic circuit design 102. The system 100 may not determine the credit 112 for other types of components in the electronic circuit design 102. Thus, the system 100 may first determine whether the slack value 110 is for a non-scan latch 104 before calculating or applying a credit 112 to the slack value 110.

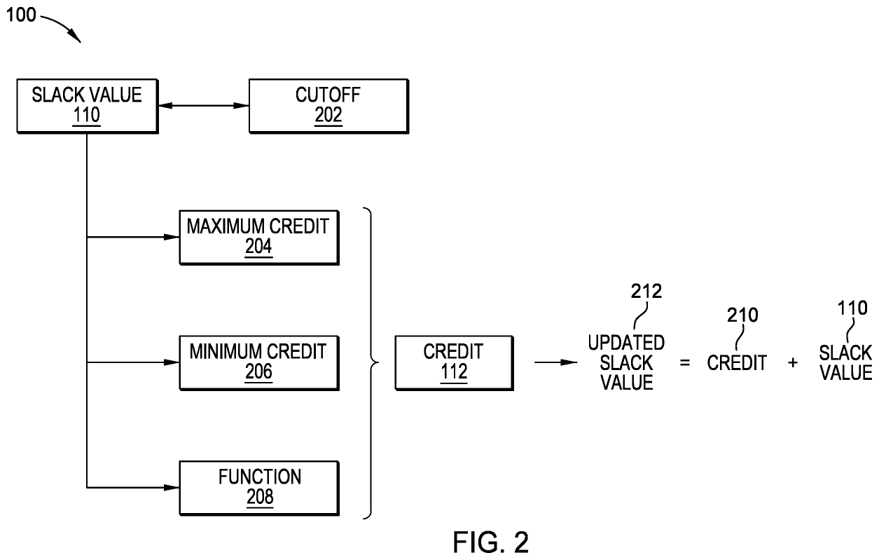

FIG. 2 illustrates the example system 100 of FIG. 1 determining the credit 112. Generally, the system 100 begins with the slack value 110 in the timing results 108. The slack value 110 may have been determined by performing timing analysis on the electronic circuit design 102. The slack value 110 may be for the non-scan latch 104 in the electronic circuit design 102.

The system 100 may compare the slack value 110 to a cutoff 202. If the slack value 110 exceeds the cutoff 202, the system 100 may determine that the credit 112 is a maximum credit 204. The maximum credit 204 may be a constant value. If the slack value 110 does not exceed the cutoff 202, the system 100 may determine the credit 112 as a function of the slack value 110. For example, if the slack value 110 does not exceed the cutoff 202, the system 100 may determine the credit 112 as the sum of a minimum credit 206 and a function 208. The function 208 may be a function of the slack value 110. For example, the function 208 may be a factor raised to the power of the slack value 110.

Each of the cutoff 202, the maximum credit 204, the minimum credit 206, and the function 208 may be specified by the system 100. For example, the cutoff 202, the maximum credit 204, the minimum credit 206, and the function 208 may be specified by design rules of the system 100. Alternatively, the cutoff 202, maximum credit 204, minimum credit 206, and the function 208 may be determined or provided through experiments. The system 100 may apply the cutoff 202, maximum credit 204, minimum credit 206 and the function 208 to determine the credit 112.

In some embodiments, the formula for the credit 112 may be expressed as follows:

$$credit = \{ \begin{matrix}{factor}^{slack - cutoff} + minimum credit , slack \leq cutoff \\ maximum credit , slack > cutoff\end{matrix}$$

The factor, minimum credit, maximum credit, and cutoff may be set at any suitable value (e.g., according to design rules or experimentation). For example, the maximum credit may be 4, the minimum credit may be 0, the factor may be 1.6, and the cutoff may be 5 (all expressed in work units or the unit/measure of time used in the timing analysis). Notably, if the slack value 110 is less than or equal to the cutoff 202, then the credit 112 is the sum of the minimum credit 206 and the factor raised to the power of the difference between the slack value 110 and the cutoff 202. If the slack value 110 is greater than the cutoff 202, then the credit 112 is the maximum credit 204. In particular embodiments, the minimum credit 206 and/or the maximum credit 204 may include an applied offset.

After the system 100 determines the credit 112, the system 100 may use the credit 112 to determine an updated slack value 212. In the example of FIG. 2, the updated slack value 212 is the sum of the credit 112 and the slack value 110. The system 100 may replace the slack value 110 in the timing results 108 with the updated slack value 212. In this manner, the system 100 updates the timing results 108 to remove some of the pessimism introduced by the margin 106 on the non-scan latch 104.

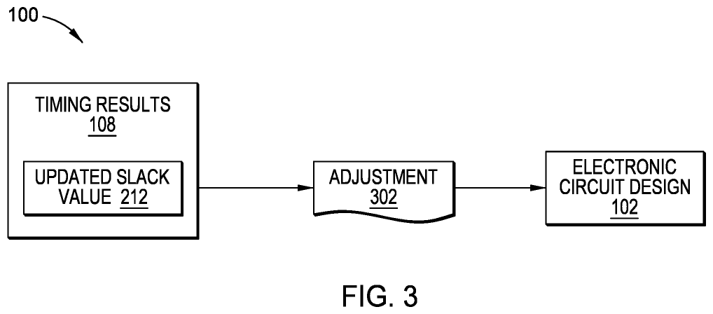

FIG. 3 illustrates the system 100 of FIG. 1 adjusting the electronic circuit design 102. The system 100 may begin with the timing results 108 that include the updated slack value 212. As discussed previously, the updated slack value 212 may be the original slack value 110 updated with the credit 112 that was determined based on the slack value 110. By updating the slack value 110, the system 100 may produce the updated slack value 212 and remove some of the pessimism introduced by the margin 106 on the non-scan latch 104.

The system 100 may use the timing results 108 to determine an adjustment 302 to the electronic circuit design 102. For example, the timing results 108 with the updated slack value 212 may reveal opportunities for improved timing or power recovery in the electronic circuit design 102. The system 100 may determine the adjustment 302 to be made to the electronic circuit design 102 to improve timing or recover power in the electronic circuit design 102. For example, the adjustment 302 may include removing certain gates from the electronic circuit design 102 or moving connections in the electronic circuit design 102. The system 100 may determine any suitable number of adjustments 302 using the timing results 108. Making the adjustments 302 may collectively improve timing and power in the electronic circuit design 102.

After determining the adjustment 302, the system 100 may make the adjustment 302 to the electronic circuit design 102. For example, the system 100 may add or remove gates from the electronic circuit design 102. As another example, the system 100 may move or shift electronic connections in the electronic circuit design 102. By making these adjustments 302 to the electronic circuit design 102, the system 100 may improve timing in the electronic circuit design 102. Additionally, the system 100 may improve power consumption in the electronic circuit design 102. As a result, by updating the slack value 110 using the credit 112, the system 100 may discover or detect additional adjustments 302 that may be made to the electronic circuit design 102. By making these adjustments 302 to the electronic circuit design 102, the system 100 may improve various characteristics of the electronic circuit design 102 (e.g., gate count, area, timing, and/or power consumption) in certain embodiments.

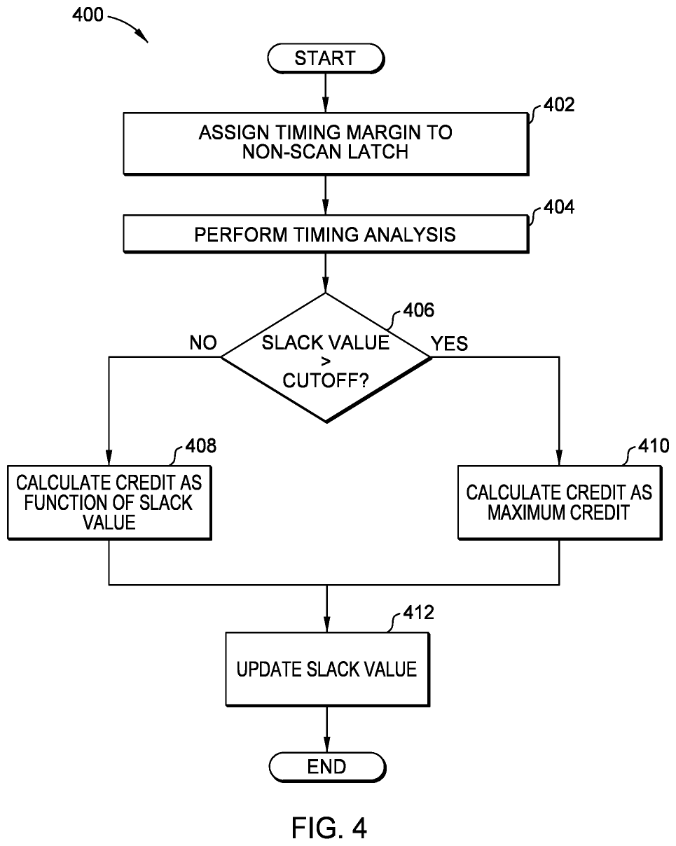

FIG. 4 is a flowchart of an example method 400 performed in the system 100 of FIG. 1. In particular embodiments, a computer system (e.g., the computer 501 shown in FIG. 5) performs the method 400. By performing the method 400, the computer system may update a slack value 110 for a non-scan latch 104 in an electronic circuit design 102. The update to the slack value 110 may remove some of the pessimism that was introduced by a margin 106 for the non-scan latch 104.

In block 402, the computer system assigns a timing margin 106 to a non-scan latch 104. The non-scan latch 104 may be part of an electronic circuit design 102. The non-scan latch 104 may be one of the electronic circuit components in the electronic circuit design 102. The non-scan latch 104 may store values that are propagated to the non-scan latch 104 from other portions of the electronic circuit design 102. The non-scan latch 104 may defer from a scanned latch, in that the non-scan latch 104 does not include an additional input that allows for values to be directly inputted into the non-scan latch 104. For example, as opposed to propagating the values to the non-scan latch 104 through other portions of the electronic circuit design 102. As a result, the non-scan latch 104 may be more difficult to test, but the non-scan latch 104 may consume less power than the scan latch.

Because the non-scan latch 104 may be more difficult to test, the computer system may introduce the timing margin 106 for the non-scan latch 104 to relax timing constraints on the non-scan latch 104. As a result, the non-scan latch 104 may not limit or constrain the frequency of the clock signal used to drive the electronic circuit design 102. Stated differently, the timing margin 106 may ensure that the non-scan latch 104 is not on the frequency limiting path in the electronic circuit design 102. The timing margin 106, however, may introduce excess pessimism in the timing analysis for the non-scan latch 104.

In block 404, the computer system performs timing analysis on the electronic circuit design 102. The timing analysis may produce the timing results 108. The timing results 108 may indicate timing characteristics of components of the electronic circuit design 102. For example, the timing results 108 may include slack values 110 for the non-scan latch 104 and for other components of the electronic circuit design 102. The slack values 110 for the non-scan latch 104 may indicate differences between when signals arrive or leave the non-scan latch 104 and when the signals should or are scheduled to arrive or leave the non-scan latch 104. Negative slack values 110 may indicate that the signals are arriving or leaving the non-scan latch 104 too late. Positive slack values 110 may indicate that the signals are arriving or leaving the non-scan latch 104 early. The computer system may use the slack values 110 to determine the credit 112 for updating the slack values 110.

In block 406, the computer system compares the slack value 110 in the timing results 108 to the cutoff 202. The cutoff 202 may be specified by design rules or experiments. If the slack value 110 does not exceed the cutoff 202, then the computer system calculates the credit 112 as a function of the slack value 110 in block 408. For example, the computer system may determine that the credit 112 is a sum of a minimum credit 206 and a function 208. In this manner, the computer system limits the credit 112 to the minimum credit 206 regardless of how small the slack value 110 is. The function 208 may produce a value based on the slack value 110. In some embodiments, the function 208 is expressed as a factor raised to the power of a difference between the slack value 110 and the cutoff 202. The minimum credit 206 and the factor may be specified by design rules or experimentation.

If the slack value 110 exceeds the cutoff 202, the computer system may calculate the credit 112 as a maximum credit 204 in block 410. The maximum credit 204 may be specified by design rules or experimentation. In this manner, the computer system limits the credit 112 to the maximum credit 204 regardless of how large the slack value 110 is.

In block 412, the computer system updates the slack value 110 using the determined credit 112. For example, the computer system may update the slack value 110 by adding the credit 112 to the slack value 110 to produce the updated slack value 212. By adding the credit 112 to the slack value 110, the computer system may remove some of the pessimism introduced by the timing margin 106 for the non-scan latch 104. By removing some of this pessimism, the computer system may reveal additional opportunities to improve the operation of the electronic circuit design 102. For example, by updating the slack value 110, the computer system may reveal additional opportunities to improve timing or power consumption in the electronic circuit design 102, in certain embodiments.

The computer system may determine the adjustment 302 using the updated slack value 212. For example, the adjustment 302 may include adding or removing gates from the electronic circuit design 102. Additionally, the adjustment 302 may include moving or shifting electrical connections in the electronic circuit design 102. The computer system may make the adjustment 302 to the electronic circuit design 102 to improve any suitable characteristic of the electronic circuit design 102. For example, making the adjustment 302 to the electronic circuit design 102 may improve the gate count, area, timing, and/or power consumption of the electronic circuit design 102, in certain embodiments.

In summary, the system 100 may analyze the slack values 110 (e.g., a measure of whether a signal reaches a destination within a required amount of time) produced during timing analysis to determine whether a credit 112 should be applied to reduce the impact of timing margins 106 introduced for non-scan latches 104. The credit 112 may be determined as a function 208 of the slack values 110 up to a certain cutoff 202 for the slack values 110. By adjusting the slack values 110 using the credit 112, the system 100 may reduce or offset some of the pessimism introduced by unnecessary or overly large timing margins 106 for the non-scan latches 104. In this manner, the system 100 may provide or reveal additional adjustments 302 that may be made to the circuit design 102, including providing opportunities for power recovery.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure is not limited to specific described embodiments. Instead, any combination of the features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the aspects, features, embodiments and advantages discussed herein are merely illustrative and are not considered elements or limitations of the appended claims except where explicitly recited in a claim(s).

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.”

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

FIG. 5 illustrates an example computing environment 500. Computing environment 500 contains an example of an environment for the execution of at least some of the computer code involved in performing the described methods, such as time analysis code 550. In addition to block 550, computing environment 500 includes, for example, computer 501, wide area network (WAN) 502, end user device (EUD) 503, remote server 504, public cloud 505, and private cloud 506. In this embodiment, computer 501 includes processor set 510 (including processing circuitry 520 and cache 521), communication fabric 511, volatile memory 512, persistent storage 513 (including operating system 522 and block 550, as identified above), peripheral device set 514 (including user interface (UI) device set 523, storage 524, and Internet of Things (IoT) sensor set 525), and network module 515. Remote server 504 includes remote database 530. Public cloud 505 includes gateway 540, cloud orchestration module 541, host physical machine set 542, virtual machine set 543, and container set 544.

COMPUTER 501 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 530. As is well understood in the art of computer technology, and depending upon the technology, performance of a computer-implemented method may be distributed among multiple computers and/or between multiple locations. On the other hand, in this presentation of computing environment 500, detailed discussion is focused on a single computer, specifically computer 501, to keep the presentation as simple as possible. Computer 501 may be located in a cloud, even though it is not shown in a cloud in FIG. 5. On the other hand, computer 501 is not required to be in a cloud except to any extent as may be affirmatively indicated.

PROCESSOR SET 510 includes one, or more, computer processors of any type now known or to be developed in the future. Processing circuitry 520 may be distributed over multiple packages, for example, multiple, coordinated integrated circuit chips. Processing circuitry 520 may implement multiple processor threads and/or multiple processor cores. Cache 521 is memory that is located in the processor chip package(s) and is typically used for data or code that should be available for rapid access by the threads or cores running on processor set 510. Cache memories are typically organized into multiple levels depending upon relative proximity to the processing circuitry. Alternatively, some, or all, of the cache for the processor set may be located “off chip.” In some computing environments, processor set 510 may be designed for working with qubits and performing quantum computing.

Computer readable program instructions are typically loaded onto computer 501 to cause a series of operational steps to be performed by processor set 510 of computer 501 and thereby effect a computer-implemented method, such that the instructions thus executed will instantiate the methods specified in flowcharts and/or narrative descriptions of computer-implemented methods included in this document (collectively referred to as “the described methods”). These computer readable program instructions are stored in various types of computer readable storage media, such as cache 521 and the other storage media discussed below. The program instructions, and associated data, are accessed by processor set 510 to control and direct performance of the described methods. In computing environment 500, at least some of the instructions for performing the described methods may be stored in block 550 in persistent storage 513.

COMMUNICATION FABRIC 511 is the signal conduction path that allows the various components of computer 501 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 512 is any type of volatile memory now known or to be developed in the future. Examples include dynamic type random access memory (RAM) or static type RAM. Typically, volatile memory 512 is characterized by random access, but this is not required unless affirmatively indicated. In computer 501, the volatile memory 512 is located in a single package and is internal to computer 501, but, alternatively or additionally, the volatile memory may be distributed over multiple packages and/or located externally with respect to computer 501.

PERSISTENT STORAGE 513 is any form of non-volatile storage for computers that is now known or to be developed in the future. The non-volatility of this storage means that the stored data is maintained regardless of whether power is being supplied to computer 501 and/or directly to persistent storage 513. Persistent storage 513 may be a read only memory (ROM), but typically at least a portion of the persistent storage allows writing of data, deletion of data and re-writing of data. Some familiar forms of persistent storage include magnetic disks and solid state storage devices. Operating system 522 may take several forms, such as various known proprietary operating systems or open source Portable Operating System Interface-type operating systems that employ a kernel. The code included in block 550 typically includes at least some of the computer code involved in performing the described methods.

PERIPHERAL DEVICE SET 514 includes the set of peripheral devices of computer 501. Data communication connections between the peripheral devices and the other components of computer 501 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 523 may include components such as a display screen, speaker, microphone, wearable devices (such as goggles and smart watches), keyboard, mouse, printer, touchpad, game controllers, and haptic devices. Storage 524 is external storage, such as an external hard drive, or insertable storage, such as an SD card. Storage 524 may be persistent and/or volatile. In some embodiments, storage 524 may take the form of a quantum computing storage device for storing data in the form of qubits. In embodiments where computer 501 is required to have a large amount of storage (for example, where computer 501 locally stores and manages a large database) then this storage may be provided by peripheral storage devices designed for storing very large amounts of data, such as a storage area network (SAN) that is shared by multiple, geographically distributed computers. IoT sensor set 525 is made up of sensors that can be used in Internet of Things applications. For example, one sensor may be a thermometer and another sensor may be a motion detector.

NETWORK MODULE 515 is the collection of computer software, hardware, and firmware that allows computer 501 to communicate with other computers through WAN 502. Network module 515 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 515 are performed on the same physical hardware device. In other embodiments (for example, embodiments that utilize software-defined networking (SDN)), the control functions and the forwarding functions of network module 515 are performed on physically separate devices, such that the control functions manage several different network hardware devices. Computer readable program instructions for performing the described methods can typically be downloaded to computer 501 from an external computer or external storage device through a network adapter card or network interface included in network module 515.

WAN 502 is any wide area network (for example, the internet) capable of communicating computer data over non-local distances by any technology for communicating computer data, now known or to be developed in the future. In some embodiments, the WAN 502 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 503 is any computer system that is used and controlled by an end user (for example, a customer of an enterprise that operates computer 501), and may take any of the forms discussed above in connection with computer 501. EUD 503 typically receives helpful and useful data from the operations of computer 501. For example, in a hypothetical case where computer 501 is designed to provide a recommendation to an end user, this recommendation would typically be communicated from network module 515 of computer 501 through WAN 502 to EUD 503. In this way, EUD 503 can display, or otherwise present, the recommendation to an end user. In some embodiments, EUD 503 may be a client device. such as thin client, heavy client, mainframe computer, desktop computer and so on.

REMOTE SERVER 504 is any computer system that serves at least some data and/or functionality to computer 501. Remote server 504 may be controlled and used by the same entity that operates computer 501. Remote server 504 represents the machine(s) that collect and store helpful and useful data for use by other computers, such as computer 501. For example, in a hypothetical case where computer 501 is designed and programmed to provide a recommendation based on historical data, then this historical data may be provided to computer 501 from remote database 530 of remote server 504.

PUBLIC CLOUD 505 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 505 is performed by the computer hardware and/or software of cloud orchestration module 541. The computing resources provided by public cloud 505 are typically implemented by virtual computing environments that run on various computers making up the computers of host physical machine set 542, which is the universe of physical computers in and/or available to public cloud 505. The virtual computing environments (VCEs) typically take the form of virtual machines from virtual machine set 543 and/or containers from container set 544. It is understood that these VCEs may be stored as images and may be transferred among and between the various physical machine hosts, either as images or after instantiation of the VCE. Cloud orchestration module 541 manages the transfer and storage of images, deploys new instantiations of VCEs and manages active instantiations of VCE deployments. Gateway 540 is the collection of computer software, hardware, and firmware that allows public cloud 505 to communicate through WAN 502.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 506 is similar to public cloud 505, except that the computing resources are only available for use by a single enterprise. While private cloud 506 is depicted as being in communication with WAN 502, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 505 and private cloud 506 are both part of a larger hybrid cloud.

While the foregoing is directed to particular embodiments, other and further embodiments may be devised without departing from the basic scope thereof, and the scope thereof is determined by the claims that follow.

What is claimed is:

1. A method comprising:
assigning a timing margin to a non-scan latch of a circuit design;
performing a timing analysis on the circuit design using the timing margin for the non-scan latch to produce timing results for the circuit design, wherein the timing results comprise a slack value;
calculating a credit based on the slack value; and
updating the slack value based on the credit.

2. The method of claim 1, wherein updating the slack value comprises adding the credit to the slack value.

3. The method of claim 1, wherein calculating the credit is in response to determining that the slack value is for the non-scan latch.

4. The method of claim 1, wherein calculating the credit comprises limiting the credit based on one or more of a maximum, a minimum, or a cutoff.

5. The method of claim 1, wherein calculating the credit comprises determining the credit to be a constant value in response to determining that the slack value exceeds a cutoff.

6. The method of claim 1, wherein calculating the credit comprises determining the credit according to a function of the slack value in response to determining that the slack value is less than a cutoff.

7. The method of claim 1, further comprising adjusting the circuit design based on the updated slack value.

8. A system comprising:
a memory; and
a processor communicatively coupled to the memory, wherein the processor is configured to:
assign a timing margin to a non-scan latch of a circuit design;
perform a timing analysis on the circuit design using the timing margin for the non-scan latch to produce timing results for the circuit design, wherein the timing results comprise a slack value;
calculate a credit based on the slack value; and
update the slack value based on the credit.

9. The system of claim 8, wherein updating the slack value comprises adding the credit to the slack value.

10. The system of claim 8, wherein calculating the credit is in response to determining that the slack value is for the non-scan latch.

11. The system of claim 8, wherein calculating the credit comprises limiting the credit based on one or more of a maximum, a minimum, or a cutoff.

12. The system of claim 8, wherein calculating the credit comprises determining the credit to be a constant value in response to determining that the slack value exceeds a cutoff.

13. The system of claim 8, wherein calculating the credit comprises determining the credit according to a function of the slack value in response to determining that the slack value is less than a cutoff.

14. The system of claim 8, wherein the processor is further configured to adjust the circuit design based on the updated slack value.

15. A non-transitory computer readable medium storing instructions that, when executed by a processor, cause the processor to:
perform a timing analysis on a circuit design to produce timing results comprising a slack value for a non-scan latch of the circuit design;
calculate a credit based on the slack value; and
update the slack value based on the credit.

16. The computer readable medium of claim 15, wherein updating the slack value comprises adding the credit to the slack value.

17. The computer readable medium of claim 15, wherein calculating the credit is in response to determining that the slack value is for the non-scan latch.

18. The computer readable medium of claim 15, wherein calculating the credit comprises limiting the credit based on one or more of a maximum, a minimum, or a cutoff.

19. The computer readable medium of claim 15, wherein calculating the credit comprises determining the credit to be a constant value in response to determining that the slack value exceeds a cutoff.

20. The computer readable medium of claim 15, wherein calculating the credit comprises determining the credit according to a function of the slack value in response to determining that the slack value is less than a cutoff.
